(19) United States
(12) Patent Application Publication
(10) Pub. No.: US 2026/0113111 A1
(43) Pub. Date: Apr. 23, 2026

(54) Power-Aware: DFOS Deployment A Hybrid Heuristic and Integer Linear Programming Strategy

(71) Applicant: NEC Laboratories America, Inc., Princeton, NJ (US)

(72) Inventors: Yangmin Ding, East Brunswick, NJ (US); Ting Wang, West Windsor, NJ (US); Md Zahidul Islam, Bayonne, NJ (US)

(73) Assignee: NEC Laboratories America, Inc., Princeton, NJ (US)

(21) Appl. No.: 19/360,912

(22) Filed: Oct. 16, 2025

Related U.S. Application Data
(60) Provisional application No. 63/708,418, filed on Oct. 17, 2024.

(51) Int. Cl. H04B 10/079; G06F 1/30

(52) U.S. Cl. CPC H04B 10/0791; G06F 1/30

(57) ABSTRACT

A novel, two-stage Distributed Fiber Optic Sensor (DFOS) placement strategy and method that ensures resilient monitoring of critical infrastructure during electrical power supply failures. This strategy and method combines a heuristic algorithm, PURE (Power Source-aware Route Exploration), with Integer Linear Programming (ILP) optimization. The PURE algorithm explores potential DFOS routes while explicitly considering the dependency of DFOS devices on the electrical power distribution network, ensuring routes electrically powered by the same electrical power feeder are disjoint. Subsequently, the ILP selects the optimal set of DFOS placements to minimize the total number of deployed sensors while meeting critical infrastructure monitoring requirements, such as redundant monitoring for high-importance links. The method enhances the observability of critical links, achieving 100% monitoring coverage for important links during simulated power outages affecting an electric feeder.

### CROSS REFERENCE TO RELATED APPLICATIONS

This application claims the benefit of U.S. Provisional Patent Application Ser. No. 63/708,418 filed Oct. 17, 2024, the entire contents of which is incorporated by reference as if set forth at length herein.

### FIELD OF THE INVENTION

This application relates generally to distributed fiber optic sensing (DFOS) systems and methods. More particularly, it pertains to the monitoring of critical infrastructures using DFOS in the event of power supply failures.

### BACKGROUND OF THE INVENTION

Distributed Acoustic Sensing (DAS) is a DFOS technology that uses fiber optic cables to detect acoustic vibrations. Its unique ability to detect small vibrations over long distances in real-time makes it an invaluable tool for monitoring and protecting critical infrastructures such as railroads, telecommunications networks, bridges, roads and electrical power generation and distribution systems.

Despite such known utility, there exists a lack of guidance on the placement of DFOS systems and devices to ensure the resilient monitoring of critical infrastructure. Existing placement strategies primarily address DFOS placement with respect to an optical fiber network topology and operational constraints, oftentimes overlooking electrical power dependency of DFOS devices.

The increasing frequency and duration of electrical power interruptions, caused by extreme weather events and other causes both natural and man-made, render assumptions of always-available electrical power unreliable. Accordingly, if an electrical power interruption occurs in an electrical power feeder, all DFOS systems and devices electrically powered by that feeder may go offline, compromising DFOS monitoring at a time when it is most needed. This is particularly problematic if critical infrastructure is being monitored by the DFOS systems and devices.

### SUMMARY OF THE INVENTION

An advance in the art is made according to aspects of the present disclosure directed to an innovative approach to DFOS placement that enables “resilient monitoring” of critical infrastructure using DFOS in the event of power supply failures. In sharp contrast to the prior art our inventive approach is a DFOS placement strategy that explicitly considers electrical power supply constraints of DFOS systems and devices.

As we shall show and describe, our inventive, computer-implemented DFOS placement strategy is a two-stage process that minimizes the cost of DFOS installation while maximizing coverage resilience against electrical power failures.

This strategy and method combines a heuristic algorithm, PURE (Power Source-aware Route Exploration), with Integer Linear Programming (ILP) optimization. The PURE algorithm explores potential DFOS routes while explicitly considering the dependency of DFOS devices on an electrical power distribution network, ensuring routes electrically powered by the same electrical power feeder are disjoint. Subsequently, the ILP selects the optimal set of DFOS placements to minimize the total number of deployed sensors while meeting critical infrastructure monitoring requirements, such as redundant monitoring for high-importance links. The method enhances the observability of critical links, achieving 100% monitoring coverage for important links during simulated power outages affecting an electric feeder.

Heuristic Algorithm (PURE) for Power-Source-Aware Route Exploration: The PURE algorithm identifies all possible linear, non-branching optical fiber routes for each potential DFOS location (node) within its maximum sensing range (R). Critically, PURE is power-source-aware, ensuring that the identified optical fiber routes for DFOS devices powered by a same electric power feeder zone are spatially disjoint. This prevents the simultaneous failure of redundant monitoring due to a single feeder outage.

Integer Linear Programming (ILP) for Optimized Sensor Placement: The ILP algorithm takes the set of possible routes from PURE and selects an optimal subset of DFOS locations. The ILP's objective is to minimize the total number of DFOS devices while satisfying a required monitoring level for all optical fiber links, especially providing redundant monitoring for high-importance critical links

Advantageously, by integrating optical fiber, electrical power, and critical infrastructure constraints, our inventive method establishes a resilient DFOS network design that maintains monitoring continuity even during prolonged electrical power feeder outages

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative power source-unaware DFOS sensing route according to aspects of the present disclosure.

FIG. 3 is a schematic diagram showing illustrative power source-aware DFOS sensing route according to aspects of the present disclosure.

FIG. 4 is a flow diagram of an illustrative overall method according to aspects of the present invention.

FIG. 5 is a pseudo-code listing of a Power Source-aware Route Exploration (PURE) algorithm according to aspects of the present disclosure.

FIG. 6 is a flow diagram illustratively showing overall inventive methodology including overall method (top) and PURE algorithm (bottom) according to aspects of the present disclosure.

FIG. 7 is a schematic of an illustrative power network used for an experiment including an IEEE standard 33-node network according to aspects of the present invention.

FIG. 8 is a plot showing illustrative coverage comparisons between PM and BM during feeder zone outage, averaged over 100 Monte Carlo simulations according to aspects of the present disclosure.

FIG. 9 is a plot showing an illustrative telecommunications network used for experiment including a network in Atlanta, GA, USA, according to aspects of the present disclosure.

FIG. 10 is a plot showing an illustrative coverage comparison between our inventive proposed (PM) method and baseline (BM) method during feeder zone outage averaged over 100 runs according to aspects of the present disclosure.

FIG. 11 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

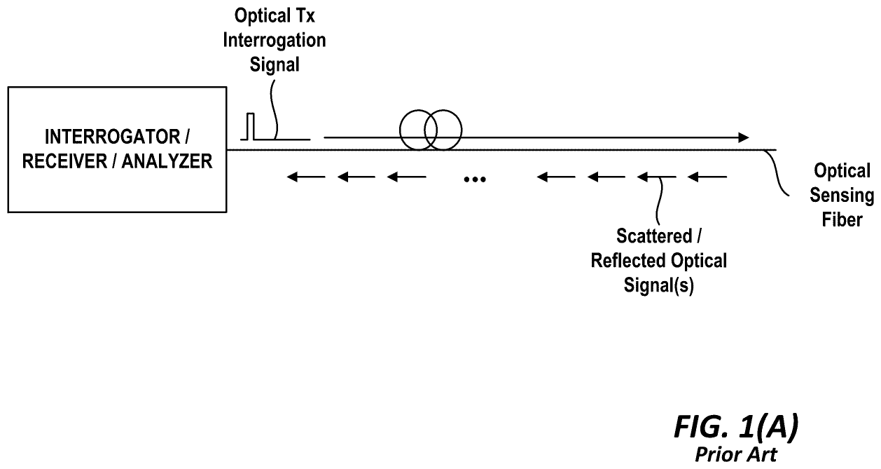

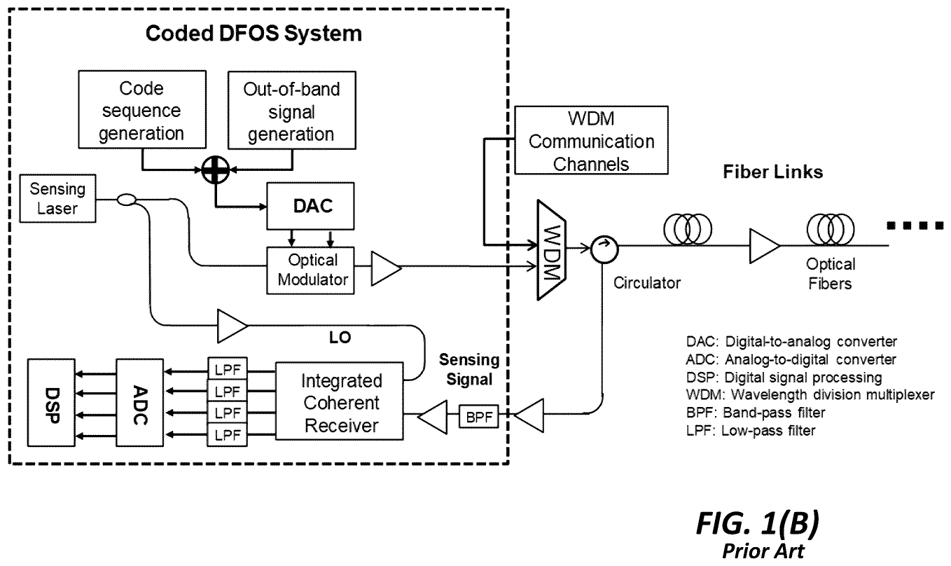

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As we have noted, DFOS allows operators to monitor extensive infrastructure remotely and continuously, leveraging the same fiber network for both communication and sensing. However, while current DFOS deployment strategies effectively consider network topology and communication constraints, they tend to overlook a critical dependency namely, the energy source that powers the DFOS devices. As those skilled in the art will understand and appreciate, in critical infrastructure, DFOS devices rely on grid power or local energy sources. If a power failure occurs, such as during a natural disaster or cyberattack, monitoring can be compromised at precisely the time when it is needed the most. Prolonged power outages—in particular—pose a major challenge, as uninterruptible power supplies (UPS) can only provide limited backup before DFOS devices go offline.

DFOS allows operators to monitor extensive infrastructure remotely and continuously, leveraging the same fiber network for both communication and sensing. However, while current DFOS deployment strategies effectively account for network topology and communication constraints, they tend to overlook a critical dependency: the energy source that powers the DFOS devices. In critical infrastructure, DFOS devices rely on grid power or local energy sources. If a power failure occurs, such as during a natural disaster or cyberattack, monitoring can be compromised at precisely the time when it is needed most. Prolonged power outages, in particular, pose a major challenge, as uninterruptible power supplies (UPS) can only provide limited backup before DFOS devices go offline.

To address this gap, we describe herein a novel DFOS placement strategy that explicitly incorporates power supply constraints thereby enabling resilient monitoring of critical infrastructure during power interruptions outages. By leveraging DFOS's remote sensing capacity, our inventive placement strategy and method maximizes coverage while minimizing the risk of unmonitored zones due to power failures.

As we shall show and describe in further detail, our method combines a heuristic algorithm, PURE (Power Source-aware Route Exploration), with Integer Linear Programming (ILP) optimization. The PURE algorithm explores all possible fiber routes that satisfy both fiber-side constraints—such as linear, non-branching routes within the operational range—and power-side constraints, ensuring that DFOS devices are powered independently. The ILP then selects the optimal set of DFOS units to minimize the total number of sensors while meeting monitoring requirements.

These two applications highlight the broad applicability of our method and its ability to maintain resilient monitoring across diverse infrastructure types.

Our inventive method optimizes the placement of DFOS units within a network to achieve resilient monitoring while minimizing the overall deployment cost. This involves determining the optimal DFOS locations and their corresponding fiber sensing routes under key constraints: (i) Fiber-side Constraints: Routes must be linear and non-branching, with each DFOS route constrained by a maximum sensing range R; (ii) Power-side Constraints: DFOS routes powered by the same feeder must remain disjoint to ensure maximum coverage during outages; and (iii) Critical Infrastructure Constraints: The system must prioritize monitoring of critical fiber links to maintain resilience.

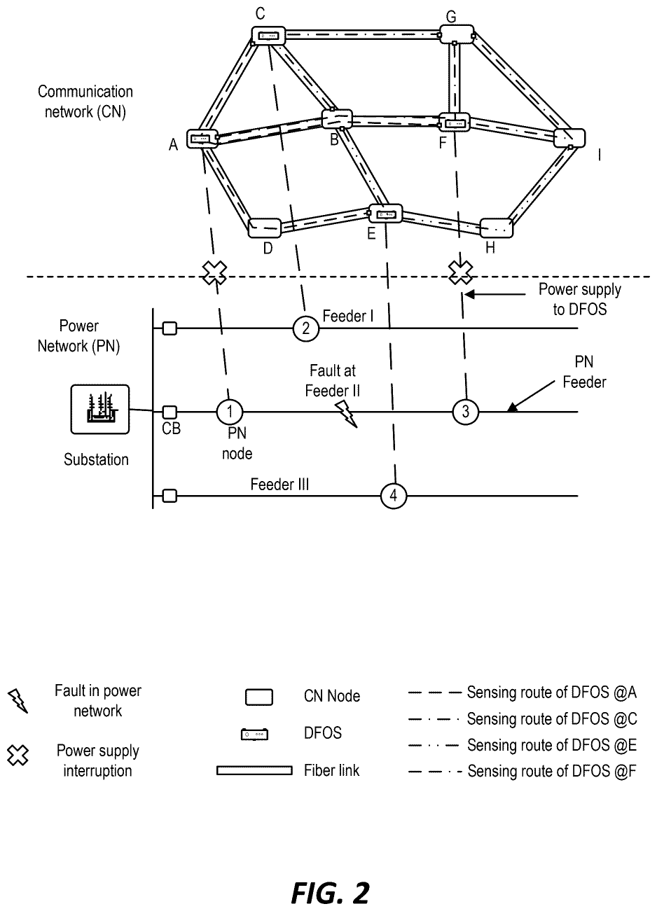

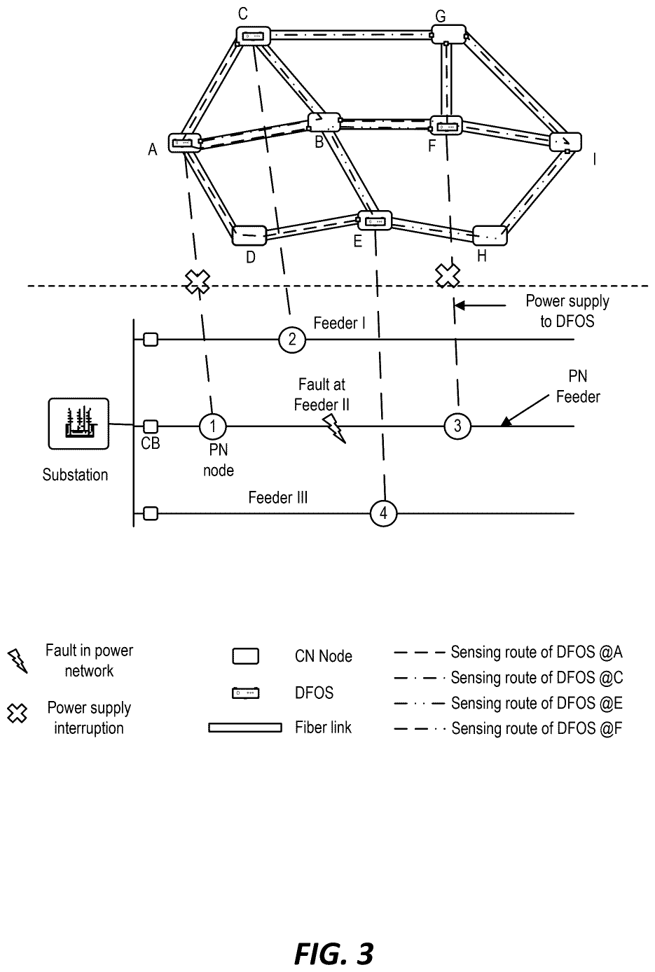

FIG. 2 and FIG. 3 provide illustrative examples illustrating the impact of power supply failure on DFOS placement and monitoring. FIG. 2 is a schematic diagram showing illustrative power source-unaware DFOS sensing route according to aspects of the present disclosure. FIG. 3 is a schematic diagram showing illustrative power source-aware DFOS sensing route according to aspects of the present disclosure.

With simultaneous reference to these two figures, we note that initially, four DFOS devices are placed at nodes A, C, E, and F in the communication network, each powered by the nearest feeder in the electrical distribution network. Under normal operating conditions, as shown in FIG. 2, the DFOS units effectively monitor all critical infrastructures. However, if a fault occurs at Feeder II, any DFOS devices powered by it (nodes A and F) would go offline during a prolonged outage, as Uninterruptible Power Supplies (UPS), if available, provide only limited backup power. This leads to a loss of monitoring for parts of the network, particularly the predetermined critical fiber link ABF, which requires redundant monitoring. Since both DFOS devices monitoring ABF depend on the Feeder II, their simultaneous failure leaves the critical linkgoing unmonitored.

To address this issue, an optimized configuration is shown in FIG. 2, where the DFOS devices at nodes A and C monitor fiber link AB, and those at nodes E and F monitors fiber link BF. In this setup, even if Feeder II fails and DFOS devices at nodes A and F go offline, the critical fiber link ABF remains monitored by the active DFOS devices at nodes C and E, which are powered by different feeders. Consequently, this configuration ensures resilient monitoring of critical infrastructure despite feeder failures, highlighting the importance of incorporating power constraints into DFOS placement strategies.

According to aspects of the present disclosure, the DFOS placement and sensing route optimization were implemented using a combined PURE algorithm and ILP approach. Our inventive technique was applied to the fiber communication network (CN) integrated with a power network (PN) to determine the optimal DFOS locations and their associated sensing routes. The methodology was structured into two stages: (1) route exploration using the heuristic algorithm PURE, and (2) selection of the optimal DFOS locations via ILP optimization.

Our two-stage DFOS placement methodology can be identified and appreciated as follows:

### Heuristic Algorithm (PURE) for Power-Source-Aware Route Exploration:

i) Problem Addressed: Traditional DFOS placement methods do not consider power supply constraints, leading to monitoring failure during power outages.
ii) Inventive Feature: The PURE algorithm explores all possible fiber routes while considering dependencies on the power network, ensuring that DFOS devices monitoring critical infrastructure are resilient to power failures. This route exploration is power-source aware and avoids overlapping routes powered by the same feeder, thus improving network reliability.

### Integer Linear Programming (ILP) for Optimized Sensor Placement:

i) Problem Addressed: Existing methods lack the ability to optimize sensor placement effectively while balancing costs and coverage, especially for critical infrastructures.
ii) Inventive Feature: The ILP formulation ensures that the minimum number of DFOS devices is deployed while maintaining coverage of critical infrastructure. The ILP integrates fiber-side, power-side, and critical infrastructure constraints, offering an optimized deployment strategy that maximizes coverage resilience while minimizing costs.

### Incorporation of Multi-Constraint Optimization:

i) Problem Addressed: Most existing DFOS placement strategies focus only on the fiber network, neglecting the interplay between the power and communication networks.
ii) Inventive Feature: our method introduces a multi-constraint approach, considering fiber-side constraints (linear routes and distance limits), power-side constraints (disjoint routes for the same power feeder), and critical infrastructure priorities (resilient monitoring of high-importance links). This holistic consideration ensures that DFOS devices can function under realistic, multi-faceted operational conditions.

### Resilience-Centric DFOS Network Design:

i) Problem Addressed: Existing approaches often fail to prioritize resilience during network planning, which is essential in critical infrastructure monitoring, particularly during extreme events like power outages.
ii) Inventive Feature: By integrating power-source constraints and critical link monitoring into both stages of the algorithm (PURE and ILP), our method enhances the overall resilience of the DFOS network, ensuring continuity of monitoring even during feeder outages. This is a significant improvement over traditional methods that only focus on fiber network topology

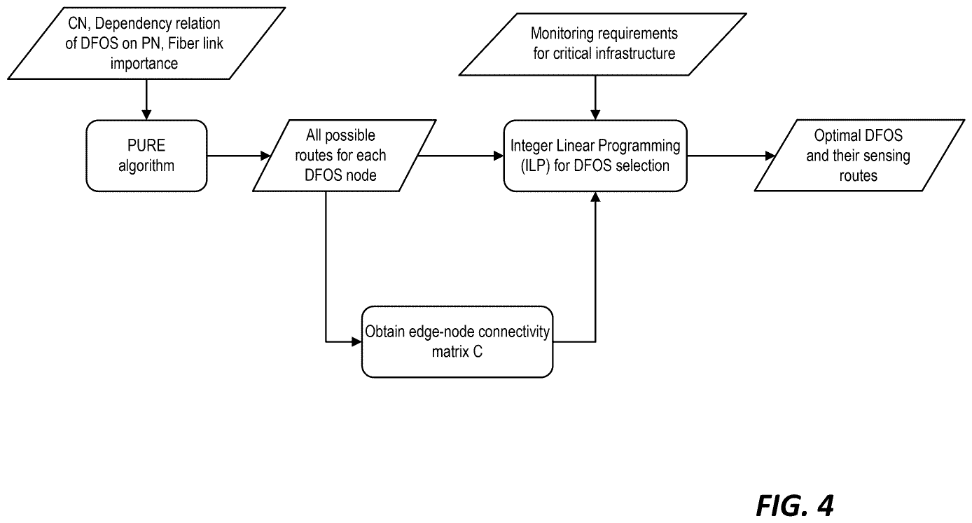

FIG. 4 is a flow diagram of an illustrative overall method according to aspects of the present invention.

As shown in that figure, with respect to a communications network (CN), in consideration of dependency relation of DFOS on a power network (PN), and optical fiber link importance, a PURE algorithm is employed and for all possible routes for each DFOS node in the CN, an edge-node connectivity matrix C is obtained and it, along with monitoring requirements for critical infrastructure are applied to an Integer Linear Programming (ILP) for DFOS selection to produce an optimal DFOS and sensing routes.

### Part-I: PURE Algorithm

The PURE algorithm is designed to explore all possible fiber routes, where each network node is considered as a potential DFOS location while satisfying both fiber-side, power-side, and monitored infrastructure-side constraints.

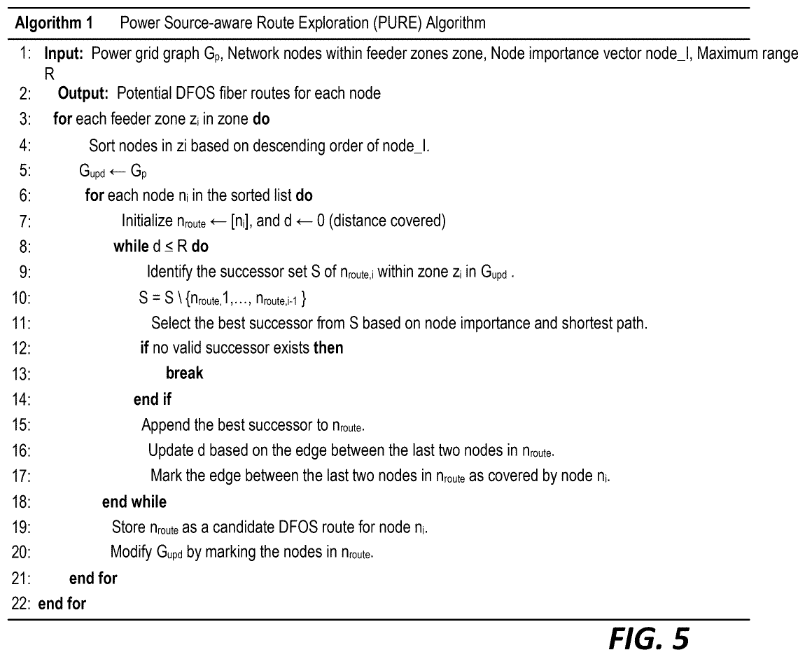

FIG. 5 is a pseudo-code listing of a Power Source-aware Route Exploration (PURE) heuristic algorithm according to aspects of the present disclosure.

A main objective of this algorithm is to identify all potential linear, non-branching fiber routes for each node, constrained to a maximum range R (line 1). Each route, denoted as n_route (line 7), is constructed based on the priority of adjacent nodes, which is assigned according to their importance node_I, reflecting the significance of the monitored infrastructure (lines 4-5). In each iteration, the algorithm begins by sorting nodes within a feeder zone z; based on the descending order of their importance (line 4). It then initializes the fiber route with a selected node and iteratively explores its successors (lines 7-8). To ensure compliance with the power-side constraints, the algorithm excludes nodes that are part of the same sourced routes (line 10). The algorithm continues expanding each route by selecting the best successor nodes (lines 11-15) until the maximum range R is reached (line 8) or no valid successors remain (lines 12-13). The constructed route is then stored as a candidate fiber path (line 17), and the network graph is updated to mark the covered nodes and edges (line 18). The algorithm further ensures that within a zone zᵢ, the fiber routes for any two DFOS devices are spatially disjoint to avoid cross-coverage, which enhances the resilience of the monitoring system.

### Part-II: Optimal DFOS Selection

Following the heuristic exploration of possible DFOS routes, an Integer Linear Program (ILP) is formulated to select the optimal set of DFOS placements. The objective of the ILP is to minimize the number of DFOS devices while ensuring that the most critical edges are adequately monitored (infrastructure-side constraint). Each edge in the network is assigned a required level of monitoring, depending on its importance and the ILP ensures that these requirements are met with the minimum number of sensors.

The decision variables in the ILP correspond to whether or not a DFOS device is placed at a given node. The constraints ensure that each edge receives the required coverage, with more critical edges requiring more DFOS devices monitoring them.

### Mathematical Formulation

Let xᵢ be a binary variable indicating whether a DFOS is placed at node i (xᵢ=1) or not (xᵢ=0). The goal is to minimize the total number of DFOS devices, subject to the requirement that each edge receives adequate monitoring.

$$\begin{matrix}minimize {\sum }_{i = 1}^{N} {x}_{i} \\ subject to Cx \geq r \\ {x}_{i} ∈ \{ 0 , 1 \} , i = 1 , 2 , … , N\end{matrix}$$

where:
N is the total number of nodes,
C is the connectivity matrix obtained from PURE algorithm, with C(e,i)=1 if edge e is monitored by node i through its associated DFOS fiber route, and 0 otherwise,
r(e) is the required level of monitoring for edge e, with r(e)=2 for critical edges and r(e)=1 for less critical edges.
x is the binary decision vector indicating whether a DFOS device is placed at each node.

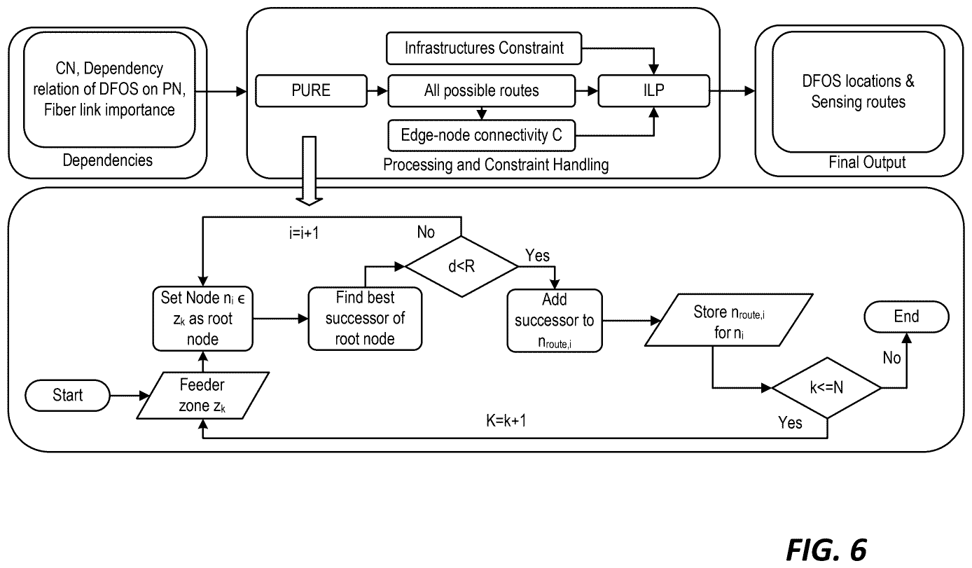

FIG. 6 is a flow diagram illustratively showing overall inventive methodology including overall method (top) and PURE algorithm (bottom) according to aspects of the present disclosure.

As illustrated in FIG. 6, the overall process begins with the PURE algorithm, which considers the dependency relations of the DFOS on both the power network and the importance of fiber links. As we have noted, this algorithm generates all possible routes for each DFOS node while ensuring compliance with fiber-side and power-side constraints. Once all possible routes are identified, the ILP module selects the optimal DFOS placements with the consideration of a connectivity matrix C and monitored infrastructure-side constraints. The final output of the ILP optimization provides the optimal DFOS nodes and their corresponding sensing routes

The flow diagram for the PURE algorithm is presented in the lower half of FIG. 6. The algorithm sorts the nodes based on their importance and iteratively explores possible fiber routes for each node being a potential DFOS location while adhering to both fiber and power constraints. At the end of each iteration, the obtained potential DFOS routes are stored for evaluation by the ILP. After identifying the possible routes, edge-node connectivity matrix C is obtained, which is a matrix of shape #edge-by-#node, with an element (j, i)=1 if an edge j is monitored by potential DFOS at node i, otherwise 0.

Then the ILP module is employed, where the objective in ILP formulation is to minimize the total number of DFOS deployed (i.e., Σ^{N} xᵢ, where xᵢ is a binary variable indicating where a DFOS is placed at node i) and the constraints are to monitor all fiber links based on their required monitoring coverage, e.g., 2 for critical links and 1 for non-critical links (i.e., Cx>r, where x is the vector of xᵢ and r is the vector of monitoring requirements of links). This ensures that the most critical fiber links receive sufficient monitoring, even under power network failures.

### Simulation and Results

To evaluate our inventive approach, five resilient monitoring scenarios are presented to demonstrate the effectiveness of our inventive method. In Scenario 1, there are no redundant link monitoring requirements, meaning all links are equally important and monitored by a single DFOS. However, from Scenario 2 to Scenario 5, a certain percentage of links—20%, 40%, 60%, and 80%, respectively—are considered more critical and require monitoring by two DFOS units for redundancy. A baseline model (BM) is developed for comparison, following the same procedure as the proposed method but without considering the power supply constraints for DFOS and using a greedy exploration strategy, as commonly used in the literature.

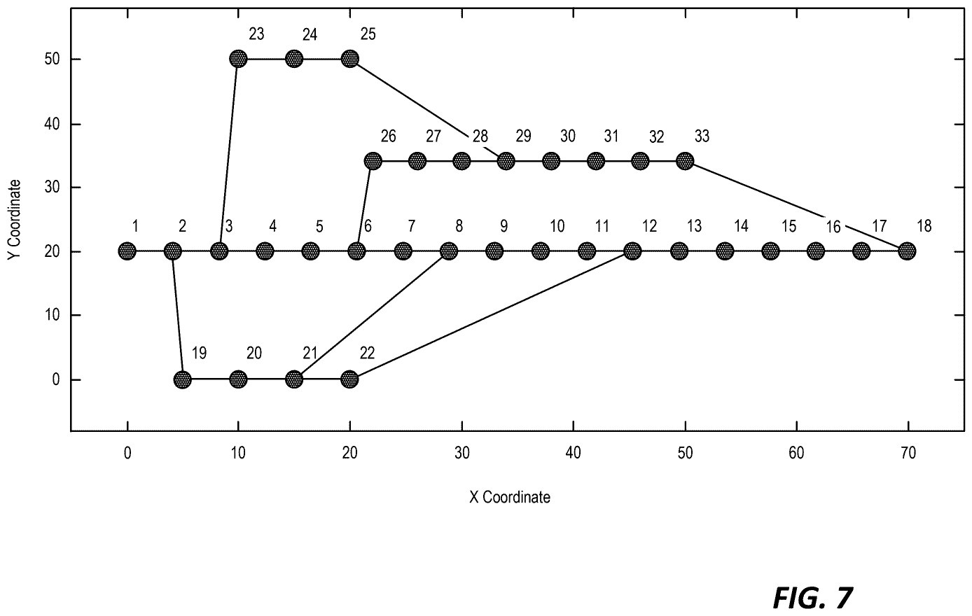

For power network infrastructure monitoring, the power network topology, as given in FIG. 7, is a schematic of an illustrative power network topology used for an experiment including an IEEE standard 33-node network according to aspects of the present invention, while the fiber communication network topology is assumed to be the same as the power network topology.

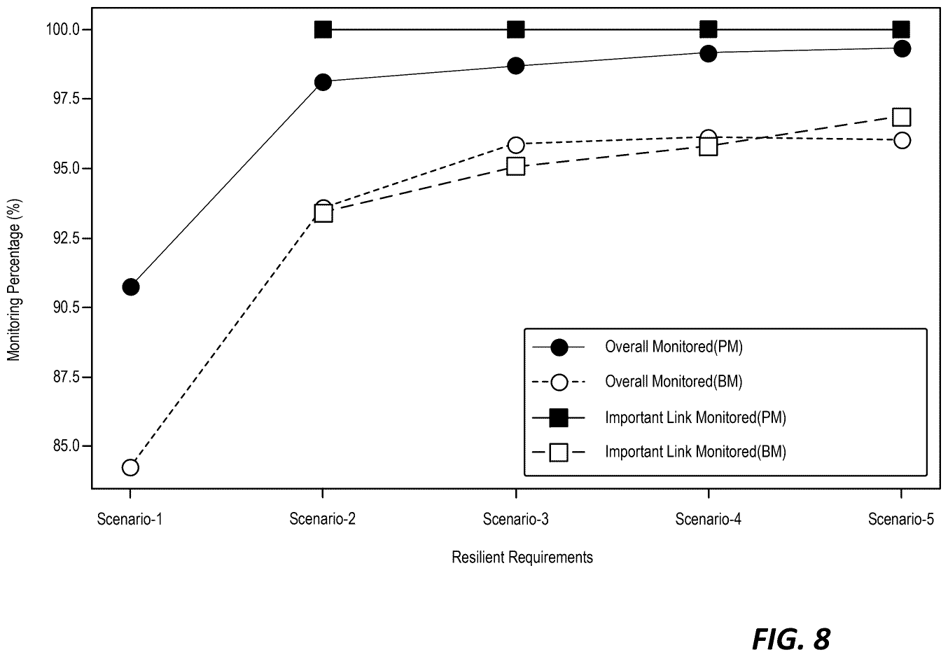

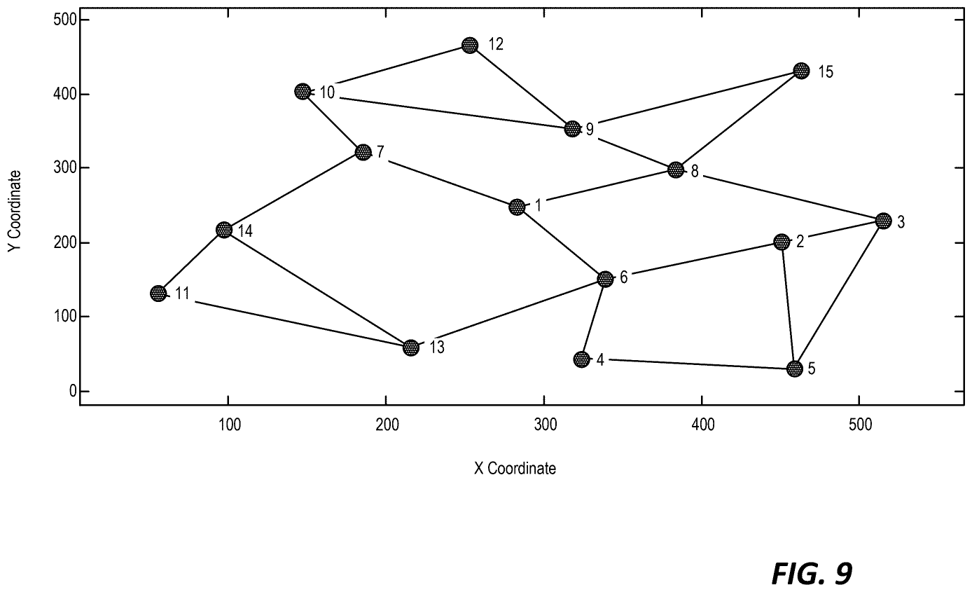

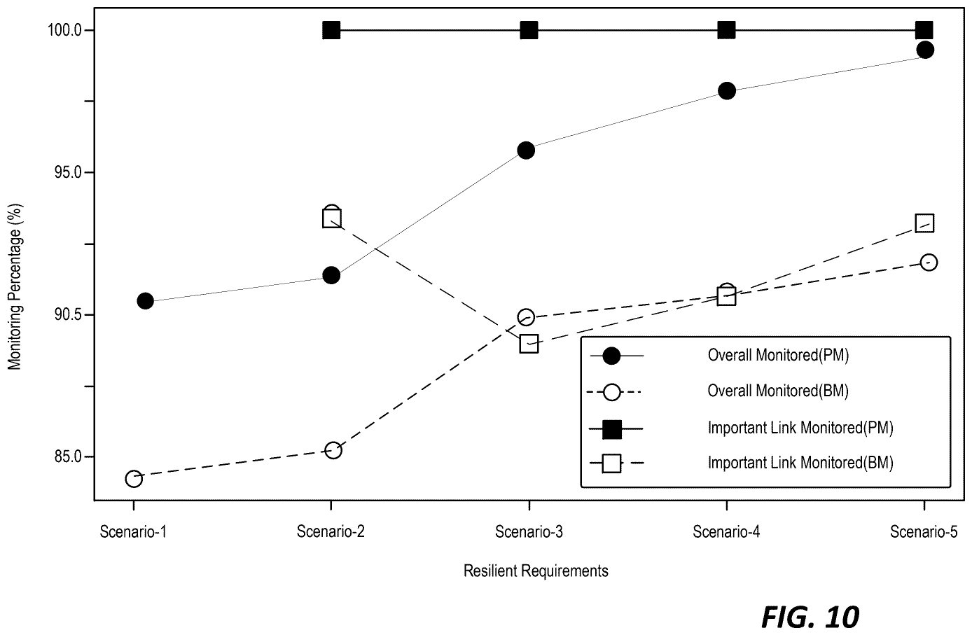

This is a valid assumption, as power utilities often deploy fiber networks alongside power lines, resulting in a similar topology. In the power network monitoring, our proposed method (PM) consistently outperforms a baseline method (BM) in terms of overall monitoring coverage across all scenarios, while using the same DFOS budget, as shown in FIG. 9 and FIG. 10, which are plots showing an illustrative telecommunications network used for experiment including a network in Atlanta, GA, USA, according to aspects of the present disclosure, and coverage comparisons between proposed method (PM) and baseline method (BM) during feeder zone outages, averaged over 100 runs. More importantly, the proposed placement method ensures 100% observability of important fiber links during power outages affecting an electric feeder, due to its awareness of DFOS power supply dependencies, as seen in FIG. 8.

As the power network topology for the area is not publicly available, we designed a power utility network supplying power to the telecommunication network nodes, following standard practices in the power domain. The proposed method shows superior performance compared to the baseline in both overall network monitoring and important link monitoring, while maintaining similar DFOS budget as the baseline, as shown in FIG. 10.

Those skilled in the art will understand and appreciate that these experiments, conducted on two different critical infrastructure systems, establish the effectiveness of our inventive DFOS placement strategy and methods.

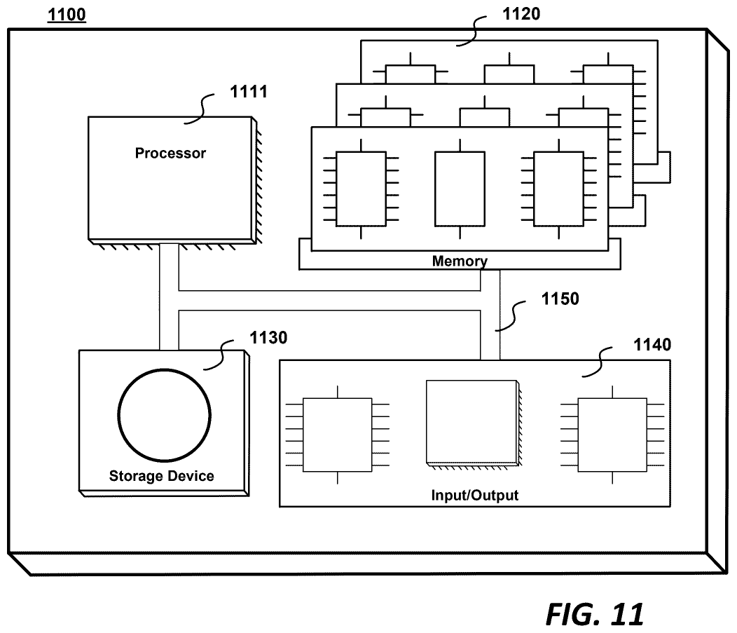

Finally, FIG. 11 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1100 as stored program control instructions.

Computer system 1100 includes processor 1110, memory 1120, storage device 1130, and input/output structure 1140. One or more input/output devices may include a display 1145. One or more busses 1150 typically interconnect the components, 1110, 1120, 1130, and 1140. Processor 1110 may be a single or multi core. Additionally, the system may include accelerators etc., further comprising a system on a chip.

Processor 1110 executes instructions in which embodiments of the present disclosure may comprise steps described in one or more of the Drawing figures. Such instructions may be stored in memory 1120 or storage device 1130. Data and/or information may be received and output using one or more input/output devices.

Memory 1120 may store data and may be a computer-readable medium, such as volatile or non-volatile memory. Storage device 1130 may provide storage for system 1100 including for example, the previously described methods. In various aspects, storage device 830 may be a flash memory device, a disk drive, an optical disk device, or a tape device employing magnetic, optical, or other recording technologies.

Input/output structures 1140 may provide input/output operations for system 1100.

At this point, those skilled in the art will understand that we have developed and validated a novel DFOS placement strategy for resilient monitoring in critical infrastructure networks. By incorporating power supply constraints into the placement process, our method ensures robust monitoring coverage, even during power outages. The simulation results across utility and telecommunication networks demonstrate the method's effectiveness in maintaining critical link observability while minimizing deployment costs.

While we have presented our inventive concepts and description using specific examples, our invention is not so limited. Accordingly, the scope of our invention should be considered in view of the following claims.

1. A computer-implemented, two-stage method for determining placement of Distributed Fiber Optic Sensing (DFOS) systems for resilient monitoring of a critical infrastructure network, the method the method comprising:
by the computer:
identifying, using a Power Source-aware Route Exploration (PURE) algorithm, a set of candidate DFOS routes for each of a plurality of nodes, while explicitly considering dependency of DFOS devices on an electrical power distribution network, and ensuring routes electrically powered by the same electrical power feeder are disjoint; and
selecting, using an Integer Linear Programming (ILP) optimization method, the optimal set of DFOS system placements to minimize the total number of deployed sensors;
wherein the selected set of DFOS system placements meet a pre-determined set of infrastructure monitoring requirements including redundant monitoring for links determined to be high importance.

2. The computer-implemented method of claim 1 wherein the selected set of DFOS system placements achieve 100% monitoring coverage for important links during simulated power outages affecting an electric feeder.

3. A computer implemented method for determining an optimal placement of Distributed Fiber Optic Sensing (DFOS) units for resilient monitoring of a critical infrastructure network, the critical infrastructure network including a communication network (CN) having a plurality of fiber links and nodes, and a power network (PN) having a plurality of electric feeder zones that supply electrical power to at least a subset of the nodes, the method comprising:
executing, by a computer processor, a heuristic algorithm, designated Power Source-aware Route Exploration (PURE), to identify a set of candidate DFOS fiber routes for each of the plurality of nodes;
generating, by the computer processor, an edge-node connectivity matrix C based on the set of candidate DFOS fiber routes, wherein C(e, i) is 1 if a fiber link e is monitored by a candidate DFOS fiber route originating from node i, and 0 otherwise; and
executing, by the computer processor, an Integer Linear Program (ILP) optimization using the edge-node connectivity matrix C to select an optimal set of DFOS unit placements.

4. The method of claim 3 wherein the executing, by the computer processor of the PURE algorithm comprises, for each feeder zone:
sorting the nodes within the feeder zone based on a descending order of a predetermined node importance;
iteratively exploring, for each node in the sorted list, a potential DFOS fiber route having a linear, non-branching path with a route length less than or equal to a maximum sensing range R; and
constraining the exploring step to ensure that the potential DFOS fiber route is spatially disjoint from any other DFOS fiber route associated with a DFOS unit that would be powered by the same feeder zone.

5. The method of claim 4 wherein the executing of the ILP optimization step comprises:
defining a binary decision variable xᵢ for each node i, where xᵢ=1 indicates placement of a DFOS unit at node i, and xᵢ=0 indicates no placement;
minimizing a total number of deployed DFOS units
$${\sum }_{i}^{N} {x}_{i} ;$$
and
satisfying a set of infrastructure-side constraints, Cx≥r, where r is a vector of required monitoring coverage levels for the fiber links, to ensure that critical fiber links are monitored by a required minimum number of DFOS units.

6. The method of claim 5, wherein the required monitoring coverage level r(e) is 2 for a critical fiber link e requiring redundant monitoring, and 1 for a non-critical fiber link e.

7. The method of claim 6, wherein the critical infrastructure network is a power distribution network, and the communication network topology is assumed to be similar to the power network topology.

8. The method of claim 7, wherein the critical infrastructure network is a telecommunication network integrated with a power utility network.

9. The method of claim 8, wherein the iterative exploring step further comprises selecting a best successor node based on node importance and shortest path distance.

10. The method of claim 9, wherein the constraining step ensures that a single power supply failure within one electric feeder zone does not compromise monitoring of any critical fiber link requiring redundant monitoring.
